(19) United States
(12) Patent Application Publication
(10) Pub. No.: US 2023/0166462 A1
(43) Pub. Date: Jun. 1, 2023

(54) METHOD FOR MANUFACTURING A THREE-DIMENSIONAL PREFORM

(71) Applicant: INSTITUT DE RECHERCHE TECHNOLOGIQUE JULES VERNE, BOUGUENAIS (FR)

(72) Inventors: Basile DE PARSCAU DU PLESSIX, BOUGUENAIS (FR); Céline LARGEAU, BOUGUENAIS (FR)

(21) Appl. No.: 17/997,115

(22) PCT Filed: Apr. 27, 2021
(86) PCT No.: PCT/EP2021/060917

§ 371 Date: Oct. 25, 2022

(30) Foreign Application Priority Data
Apr. 28, 2020 (FR) 2004228

(51) Int. Cl. B29C 70/54; B29C 70/38

(52) U.S. Cl. CPC B29C 70/543; B29C 70/545; B29C 70/382; B29K 2105/089

(57) ABSTRACT

Disclosed is a method for producing a three-dimensional preform (1) comprising the following steps: (a) depositing at least one strip (2) of fibers (5) on a three-dimensionally shaped substrate (3); (b) sewing the at least one strip (2) of fibers (5) onto the substrate (3) with at least one sewing thread (4) forming a seam (6).

### TECHNICAL FIELD

The present invention relates to the field of manufacturing parts made of composite material, in particular but not exclusively in the aeronautical, naval, wind power and automotive sectors, such parts comprising a matrix, in particular polymer or ceramic, and a fibrous reinforcement. In particular, the invention relates to a method for manufacturing a three-dimensional preform, in addition to a preform obtained by such a method, a method for manufacturing a three-dimensional part made of composite material produced from such a preform and an installation for implementing the method according to the invention.

### PRIOR ART

It is known, in particular, from the patent application EP 1 250 991 to produce three-dimensional preforms by spraying fibers, potentially mixed with a binder, onto a tool. This embodiment permits a good production rate. However, the orientation of the fibers in the preform is random which does not permit a satisfactory mechanical strength to be obtained in the part made of composite material produced from such a preform.

WO 2015/170016 discloses a method for manufacturing three-dimensional preforms by draping fibers on a tool. The adhesion of the fibers on the tool can be carried out by the presence of a binder in the fibers, said binder, in particular, being able to be activated by heating. Such a method has the advantage of being able to produce parts made of composite material with good mechanical strength due to the orientation of the fibers. However, the need for heating makes the method costly and can slow down the production rates.

Automated fiber placement machines called AFP, for “automated fiber placement” in English, or automated tape laying machines called ATL, for “automated tape layup” in English, enable this type of method to be implemented for producing three-dimensional parts made of composite material. These machines are, however, very costly and have a limited production rate due to the required heating time.

WO 2007/010050 discloses a device for the manufacture, by using a TFP (Tailored Fiber Placement) method, of a fibrous preform provided with almost any surface geometry, in which a fiber strand can be placed on a backing layer, by using guide means along a curved trajectory, said fiber strand being able to be fixed to said backing layer by using a fixing thread by means of the stitching head.

DE 101 23 064 discloses the stitching of a reinforcing fiber on a foam core using an upholstery method.

DE 10 2009 041177 discloses a method for producing a three-dimensional composite part comprising the application of a fiber onto a base textile rotating on a support.

DE 10 2014 201278 discloses a device for fixing a reinforcing strip to a backing layer. The device comprises a means for the continuous distribution of a reinforcing strip, pressing means for pressing the reinforcing strip onto the backing layer and stitching means for stitching the reinforcing strip to the backing layer.

EP 1 584 462 discloses the manufacture of a dry preform comprising successive layers of continuous reinforcement fibers.

Thus there is a need to manufacture three-dimensional parts made of composite material having good mechanical strength, at a high production rate and at a lower cost than those produced using AFP or ATL machines.

### SUMMARY OF THE INVENTION

Method for Manufacturing the Preform

In order to respond to all or some of these requirements, according to one of its aspects, the present invention proposes a method for manufacturing a three-dimensional preform, comprising the following steps:

a) laying at least one strip of fibers on a three-dimensionally shaped substrate,

b) fixing by stitching said at least one strip of fibers on the substrate, with at least one stitching thread.

The step a) is advantageously carried out so that the strip of fibers or the strips of fibers follow the shape of the substrate and is/are fixed in this position in step b).

Preferably, a strip of fibers is laid and fixed by stitching as it is gradually laid.

A method enabling a three-dimensional preform to be produced without requiring the use of an AFP or ATL machine is made possible by the invention.

“Strip of fibers” is understood to mean an assembly of fibers possibly impregnated with a material, for example in the form of a pre-impregnated tape, called “tape” in English, from a spool of dry fibers, called roving in English, a mixture of reinforcing fibers and a thermoplastic matrix thread, also known by the name “co-mixed fibers”. The strips of fibers have, for example, a width of between 1 mm and 600 mm, preferably less than 100 mm.

“Fixing by stitching” is understood to mean “assembling by means of a thread passed into a needle”. The result which is obtained is stitching with at least one thread. The installation according to the invention described below can permit such an operation to be carried out.

Advantageously, said at least one strip of fibers is laid on the substrate so as to form a ply of said three-dimensional preform, in particular with a predetermined orientation of the fibers.

“Ply” is understood to mean a layer of the three-dimensional preform comprising at least one strip of fibers, in particular a plurality of strips of fibers laid side by side.

The method may comprise the repetition of steps a) and b) at least once, so as to form at least one additional ply on the previously formed ply. The additional ply can have an orientation of fibers which is different from the orientation of fibers of the underlying ply.

Within the same strip, the fibers can have the same orientation or not have the same orientation.

By laying and fixing the strips of fibers in parallel adjacent to one another to form a ply, it is possible to provide this ply with a predefined orientation of the fibers. This orientation of the fibers within each ply makes it possible to improve the mechanical strength of the part made of composite material produced from the preform.

A circular draping can be implemented. The strip is thus laid in a circular manner.

Preferably, said at least one strip of fibers is pressed against the substrate, in particular using a roller, and preferably gradually as the strip is laid, before the fixing by stitching in step b). In this manner, the stitching is facilitated and the smoothing of the strip of fibers is improved. Moreover, by pressing, it is possible to control the laying direction of said at least one strip of fibers.

The method may comprise the step consisting of cutting the strip of fibers, or each strip of fibers, in particular after fixing by stitching, in at least one predefined location, for example after producing a complete straight line using the strip, in particular before each change in the laying direction of said at least one strip of fibers. This cutting can make it possible to limit losses of material and the formation of loops on the strip of fibers during changes of direction, for example. It is possible to use a specific blade for cutting the strip precisely and without damaging it.

The fixing by stitching in step b) is preferably carried out by displacing a stitching head, in particular using a robot or robot arm, relative to said at least one strip of fibers.

Preferably, the stitching head is displaced, preferably by means of a robot or robot arm, relative to said at least one strip of fibers, both in the laying direction of the strip and also transversely thereto on one side and then on the other side of the strip, so as to form stitches on either side thereof. The stitching is thus in the form of a zig-zag stitch around the strip of fibers or each strip of fibers.

Different stitches can be suitable, in particular, for fixing the strip of fibers after the laying thereof, the preferred stitch being the zig-zag stitch as indicated above. The width of the zig-zag stitch can be adapted to the width of the strip of fibers laid on the substrate. It should be noted that it is also possible to produce a straight stitch or chain stitch directly through the strip of fibers without departing from the scope of the invention.

In order to avoid damage to the strip of fibers during the stitching, the stitches are advantageously produced so as not to pass through the strip.

According to a particular embodiment, said at least one stitching thread is produced in a thermoplastic polymer material.

According to a further embodiment, said at least one stitching thread is produced in a different material, in particular a ceramic material or a different polymer material. In this last case, the material constituting the stitching thread can be selected from the group consisting of thermosetting polymers.

The width of said at least one strip of fibers can vary within the same preform. Such a variable width of the strip of fibers can enable the rigidity of the strip of fibers to be adapted as a function of the local curvature of the substrate, and the laying rate to be optimized. In areas of complex geometry (high curvature), it is preferable or even necessary to reduce the width of the strip so as to facilitate the laying thereof and to guarantee its flatness. In areas where the geometry is simpler (flat areas) the width of the strip can be increased so as to increase the quantity of material laid per unit of time.

Said at least one strip of fibers is preferably unwound from at least one spool before being laid in step a).

The substrate can be flexible. In this case, the method may comprise the step consisting of stretching the substrate, locally or in its entirety, and carrying out step b) on the substrate thus stretched.

When it is flexible, the substrate can be fixed, so as to be stretched locally or in its entirety, on a rigid tool, in at least one area so as to produce its three-dimensional shape. Preferably, such a rigid tool is open and/or mobile so as to free up sufficient space to carry out the stitching of the strip of fibers.

When the substrate is stretched locally a stretched area is created, the fixing of said at least one strip of fibers by stitching being carried out in the region thereof, then this stretched area of the substrate is displaced with the stitching head.

As a variant, the substrate can be rigid.

Whether it is flexible or rigid, the substrate can be produced in a thermoplastic polymer material, for example but not exclusively in polypropylene, in polyester, in polyamide, in polyetheretherketone (PEEK), in polyetherketoneketone (PEKK), in polyether sulfone (PES) and/or a polyetherimide (PEI). The substrate can be fused with the matrix of the final part made of composite material which is manufactured from the preform, during the shaping thereof. The number of foreign bodies in said part made of composite material is thus reduced, which can improve its quality.

The substrate can be produced in a material other than a polymer material, for example a woven fabric, for example a carbon fabric or glass fabric, amongst others.

Said at least one strip of fibers can comprise at least one additional element, in particular at least one sensor and/or at least one electronic circuit and/or at least one metal element and/or any type of long body and/or any element which is continuous and of small width. “Long body” is understood to mean a tube, for example. Thus cooling channels can be positioned, for example. The width of the long body is advantageously less than the width of the stitch, so as not to be pierced.

Thus it is possible to produce three-dimensional parts made of composite material comprising an electronic system. For example, it is possible to produce a part made of composite material which is capable of communicating its temperature, its internal stresses and/or its acceleration to an external or internal system, for example an electronic chip with diodes and/or a display.

The strip of fibers preferably comprises fibers selected, for example, from the group consisting of carbon fibers, glass fibers, ceramic fibers, fibers of polymer material, for example thermoplastic, in particular aramid fibers or polyester fibers, fibers of plant origin, in particular linen fibers, optical fibers, metal fibers, preferably carbon fibers and glass fibers, long bodies and a mixture thereof.

The strip of fibers can have a shape selected from the group consisting of rovings, woven fabrics, knitted fabrics, braided fabrics and a mixture thereof.

Preferably, long continuous fiber is used which will be cut only during the laying thereof.

In one embodiment, the fibers of said at least one strip of fibers are dry.

In a further embodiment, the fibers of said at least one strip of fibers are pre-impregnated. In this case, said at least one strip of fibers can comprise a mixture of reinforcing fibers previously impregnated with a polymer material, such as a polypropylene, a polyester, a polyamide, a polyetheretherketone (PEEK), a polyetherketoneketone (PEKK), a polyether sulfone (PES) and/or a polyetherimide (PEI).

In a further particular embodiment, the fibers of said at least one strip of fibers comprise reinforcing fibers selected from carbon fibers, glass fibers, ceramic fibers, aramid fibers and/or fibers of plant origin, in particular linen fibers, and fibers of polymer material selected from polypropylenes, polyamides, polyetheretherketones (PEEK) and/or polyetherketoneketones (PEKK). The fibers are thus so called “co-mixed fibers”.

Preform

A further subject of the invention, according to another of its aspects, in combination with the above, is a three-dimensional preform produced using a method as defined above.

The preform can comprise between 1 and 500 plies superposed on one another, preferably between 10 and 500 plies, preferably between 50 and 100 plies, for example approximately 100 plies. Two adjacent plies can have different orientations of fibers, for example differing by an angle of between 0° and 90°.

Method for Manufacturing a Part Made of Composite Material

The invention relates, according to another of its aspects, in combination with the above, to a method for manufacturing a three-dimensional part made of composite material, comprising the following steps:
producing a three-dimensional preform using the method as defined above,
shaping the part by consolidation or adding a matrix.

The method can comprise the step consisting of displacing the three-dimensional preform in a tool such as a mold, a press, an autoclave or an oven after producing the preform and in order to shape said preform.

The step for shaping the preform by consolidation consists, for example, in heating and/or compressing the preform in a press, an autoclave or an oven.

The step of shaping the preform by adding a matrix consists, for example, in impregnating, infusing, injecting a polymer material in liquid form into the preform placed in a mold. It comprises the polymerization of the polymer material.

The step of shaping the preform by adding a matrix can also consist, for example, in depositing, by gas cracking or by pyrolysis of an organic material (polymer, coal tar pitch, etc.), a ceramic matrix on the preform.

After the shaping step, the part made of composite material comprises a fibrous reinforcement and a polymer or ceramic matrix.

When the fibers of the three-dimensional preform are dry they constitute the fibrous reinforcement of the part made of composite material when it is shaped by adding a matrix, in particular by infusion or injection.

When the fibers of the three-dimensional preform are pre-impregnated, the fibers form the fibrous reinforcement and the polymer material impregnating the fibers forms all or part of the polymer matrix of the part made of composite material when it is shaped, in particular by consolidation.

When the fibers of the three-dimensional preform comprise a mixture of reinforcing fibers and polymer fibers, also called “co-mixed fibers”, the reinforcing fibers form the fibrous reinforcement and the fibers made of polymer material form all or part of the polymer matrix of the part made of composite material when it is shaped, in particular by consolidation.

In the case where said at least one stitching thread used for the manufacture of the three-dimensional preform is produced in the same thermoplastic polymer material as the matrix, the stitching thread can be fused with the matrix during the final shaping of the part made of composite material. This limits foreign bodies in the final part made of composite material.

In the case where said at least one stitching thread used for the manufacture of the three-dimensional preform is produced in a different polymer material from the matrix, in particular a material having a higher melting point than the melting point of the material of the matrix, the matrix and the thread are not fused, which makes it possible to improve the hot handling of the preform by a robot, for example.

Three-Dimensional Part Made of Composite Material

A further subject of the invention according to another of its aspects, in combination with the above, is a three-dimensional part made of composite material, comprising a fibrous reinforcement and a polymer matrix, obtained using the method for manufacturing a three-dimensional part made of composite material as defined above.

Such a part made of composite material produced from a three-dimensional preform, comprising at least one strip of fibers comprising at least one optical fiber, can enable information to be transferred through the part made of composite material.

Installation

The invention, according to another of its aspects, in particular in combination with the above, relates to an installation for implementing the method for manufacturing a three-dimensional preform as defined above, the installation comprising:
a three-dimensional substrate,
at least one laying head comprising at least one spool carrying said at least one wound-up strip of fibers,
at least one stitching head which is configured to stitch with at least one stitching thread said at least one strip of fibers on the substrate.

The laying head can comprise:
at least one blade for cutting the strip of fibers and/or
at least one pressing member, in particular a roller, for pressing said at least one strip of fibers against the substrate,

The installation can preferably comprise a fiber placement machine (TFP).

The stitching head preferably comprises a bobbin and a needle in a manner known per se.

The installation can comprise a rigid tool to stretch the substrate locally or in its entirety, when it is flexible.

The installation can comprise an arm, preferably robotized, in particular in the form of a gooseneck, carrying at least one stitching head. Such an arm is advantageously configured to hold the bobbin fixedly relative to the needle whilst surrounding the substrate.

In this case, the stitching head can be configured to be displaced, in particular by the arm, relative to said at least one strip of fibers so as to produce stitches on either side thereof whilst at the same time advancing.

The installation can comprise a plurality of spools, each carrying at least one wound-up strip of fibers.

In this configuration, the installation can comprise a plurality of stitching heads, each thereof being coupled to at least one spool. It is possible to lay and stitch, for example at the same time, a plurality of strips of fibers to the substrate at different locations of the substrate. This makes it possible to increase the manufacturing rate of the preform, each stitching head being responsible for laying the strip of fibers on a single predefined area.

For the manufacture of the three-dimensional preform, the spool or the spools and the stitching head can be displaced relative to the substrate. In a certain configuration of the installation, the substrate is fixed and the spool or the spools and the stitching head are mobile. In a further configuration of the installation, the substrate is mobile and the spool or the spools and the stitching head are fixed. Finally, in a final configuration of the installation, the substrate, the spool or the spools and said stitching head are mobile in a complementary manner in order to produce the desired stitches.

### BRIEF DESCRIPTION OF THE DRAWINGS

The invention can be understood more clearly by reading the following detailed description of non-limiting exemplary embodiments thereof and by examining the accompanying drawing, in which

FIG. 1 shows schematically, partially and in cross section an example of a preform produced using the method for manufacturing according to the invention,

FIG. 2 shows schematically, partially and in a view from above a part of the preform of FIG. 1,

FIG. 3 shows schematically and in perspective a ply of an example of a preform when produced by the method of the invention,

FIG. 4 shows schematically and in perspective the preform of FIG. 3 with a second ply,

FIG. 5 shows separately, schematically and in perspective the rigid substrate for the manufacture of the preform of FIGS. 3 and 4,

FIG. 6 shows schematically and in perspective a further example of a preform according to the invention,

FIG. 7 shows schematically and in cross section an example of the installation according to the invention,

FIG. 8 shows separately, schematically and in perspective a flexible substrate and its rigid support for the manufacture of a preform according to the invention,

FIG. 9 shows separately, partially and schematically an example of a strip of fibers which can be used to produce a preform according to the invention,

FIG. 10 shows separately, partially and schematically a further example of the strip of fibers,

FIG. 11 shows separately, partially and schematically a further example of the strip of fibers,

FIG. 12 shows a block diagram illustrating the steps of an example of the method for manufacturing a part made of composite material according to the invention and

FIG. 13 is a schematic view in perspective of a further example of the installation according to the invention.

### DETAILED DESCRIPTION

In the remainder of the description, elements which are identical or functionally identical bear the same reference numeral. For the purpose of concision of the present description they are not described relative to each of the figures, only the differences between the embodiments being described.

In the figures, the actual proportions have not been observed, for the sake of clarity.

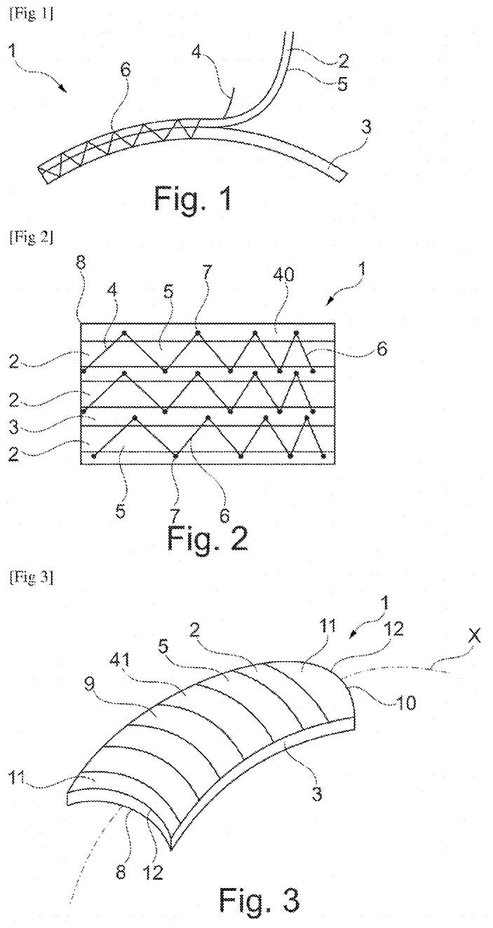

An example of a three-dimensional preform 1 produced by implementing the method according to the invention is illustrated in FIG. 1.

A strip 2 of fibers 5 is guided and laid on a three-dimensional substrate 3. In this example, the strip 2 of fibers 5 is composed of glass fibers 5 pre-impregnated with 50% by mass of polymer material, which are oriented in the strip 2 of fibers 5 in the laying direction thereof. The substrate 3 is produced in this example in a rigid thermoplastic polymer material, for example in polyamide or PEEK.

The strip 2 of fibers 5 is then stitched to the substrate 3. This fixing by stitching is carried out such that the strip 2 of fibers 5 follows the shape of the substrate 3. Stitching 6 is carried out with a thread 4.

As visible in FIG. 2, it is seen that the stitching 6 is produced on either side of the strip 2 of fibers 5, whilst advancing in the direction thereof, so as to form zig-zag stitches 7. In this example, the width between two zig-zag stitches 7, which are located opposite one another on the strip 2 of fibers 5, is greater than the width of the strip 2 of fibers 5 so as not to pass through it.

This width naturally can be different without departing from the scope of the invention. It is equally possible to use other stitches. It is equally possible to reduce the width so as to stitch through the strip of fibers.

The strips 2 of fibers 5 are laid parallel with one another and cover at least a part of the surface 40 of the underlying substrate 3 delimited by a contour 8. In this example, the strips 2 of fibers 5 do not overlap the contour 8.

As illustrated in FIG. 3, the method can comprise the step consisting of laying the strips 2 of fibers 5 so as to form a first ply 9.

In this first ply 9 the strips 2 of fibers 5 have the same width, are parallel with one another and cover more than 90% of the surface 40 of the substrate 3. The first ply 9 thus has a surface 41 delimited by a contour 10. The fibers 5 of the strips 2 of the first ply 9 are substantially parallel with one another which provides a predominant orientation to the first ply 9, in this example substantially at right-angles to the curved longitudinal axis X.

The contour 8 of the substrate 3 has two opposing edges 12 at the longitudinal ends in this example.

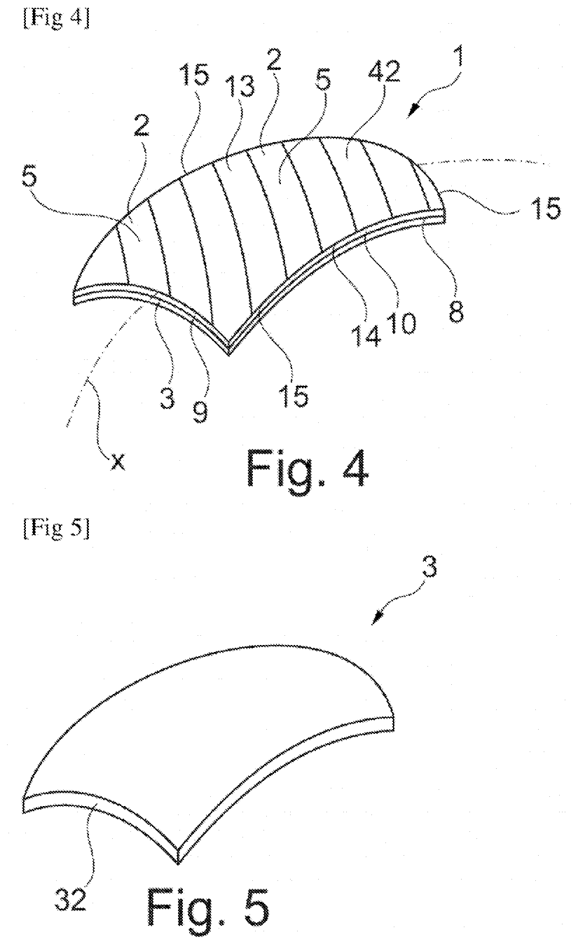

In the method according to the invention, it is possible to lay a second ply 13 on the first ply 9 as illustrated in FIG. 4. This second ply 13 is also fixed to the substrate 3 by stitching. Within the ply 13, the laying direction of the strips 2 of fibers 5 forms an angle of 45° relative to the laying direction of the strips 2 of fibers 5 of the ply 9 and thus an angle of 45° relative to the curved longitudinal axis X. As a result, the fibers 5 of the second ply 13 and the fibers 5 of the first ply 9 form an angle of 45° to one another.

In this example, the strips 2 of fibers 5 of the second ply 13 have the same width relative to one another and cover more than 90% of the surface 41 delimited by the contour 10 of the first ply 9. The second ply 13 in turn delimits a surface 42 defined by a contour 14. So that the strips 2 of fibers 5 of the second ply 13 do not overlap the contour 10 of the first ply 9, they have an end 15 having a suitable shape. The strips 2 of fibers 5 can, for example, be cut off when placed, line by line, once the strip has been laid, and preferably stitched.

It is also possible to lay and stitch other plies of strips of fibers by varying the orientation of the fibers, or not, without departing from the scope of the invention.

In the example of FIGS. 3 and 4, the substrate 3 has a double curved shape.

The substrate 3 is present in the form of a three-dimensional rigid mold 32, as in FIG. 5. The substrate has the desired shape for the preform 1. In this example, the substrate 3 in the form of the rigid mold 32 preserves its rigidity after carrying out the stitching or the stitchings of the strips 2 of fibers 5.

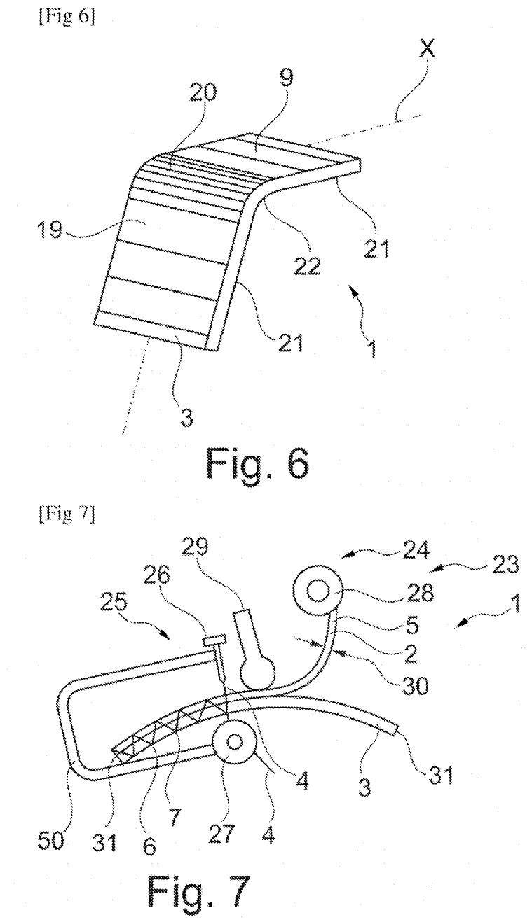

In the embodiment illustrated in FIG. 6, the substrate 3 is curved only along the longitudinal axis X, and has an area of high curvature 22 surrounded by areas of low curvature 21. The ply 9 comprises strips of different widths laid on the substrate 3, in this case wide strips 19 and narrow strips 20. The strips 19 in this example are laid on the areas of low curvature 21 and the strips 19 are laid in the area of high curvature 22.

In this example, apart from their width, the strips 19 and 20 are identical in terms of material and assembly. It is possible, however, to use strips 19 and 20 produced in different materials and/or with the fibers assembled differently.

The installation 23 is used to produce the preform 1, one example thereof being illustrated in FIG. 7. The installation 23 comprises a laying head 24 and a stitching head 25.

The laying head 24 comprises a spool 28 of wound-up strips 2 of fibers 5 and a pressing member 29, in this example in the form of a roller. The laying head 24 enables the strip 2 of fibers 5 to be guided toward the substrate 3 from the spool 28 from which it is unwound and displaced in the laying direction of the strip 2. The strip 2 is pressed onto the substrate 3 by the pressing member 29. The pressing member 29 makes it possible to facilitate the stitching of the strip 2 of fibers 5 onto the substrate 3 and to provide effective smoothing of the strip 2 of fibers. The pressing member 29 also enables the laying direction of the strip 2 of fibers 5 to be controlled.

The laying head 24 also comprises in this example a blade 30 which enables the strip 2 of fibers 5 to be cut in a predetermined and accurate manner, without damaging the strip 2, once the strip 2 is placed on a line or complete segment. The cutting of the strip 2 of fibers 5, in particular, enables the formation of loops to be avoided during changes of direction of the laying head 24, in particular at the ends 31 of the substrate 3.

The stitching head 25 comprises a needle 26 and a bobbin 27 connected fixedly together by an arm 50, in this case a robotized arm in the form of a gooseneck, which bears the stitching head 25. This stitching head enables the stitching 6 of the strip 2 of fibers 5 onto the substrate 3 to be carried out with two threads 4, one being displaced using the needle 26 and the other being unwound from the bobbin 27, so as to produce the zig-zag stitches 7. The zig-zag stitches 7 pass through the substrate 3 on either side of the strip 2 of fibers 5, preferably avoiding passing through the strip of fibers.

The arm 50 displaces the stitching head 25 relative to the strip 2 of fibers 5 so as to produce the stitching 6 in zig-zag stitches 7, whilst advancing along the strip 2 of fibers 5 during the laying thereof by the laying head 24. The stitching 6 is thus produced by alternating the stitches 7 on either side of the laid strip 2 of fibers 5.

The average speed of displacement of the stitching head 25 carried by the arm 50, in the laying direction of the strip 2, is close to the speed of displacement of the laying head 24, in the laying direction of the strip 2 of fibers 5.

In the embodiment of FIGS. 3 to 5, the substrate 3 is produced in a rigid material.

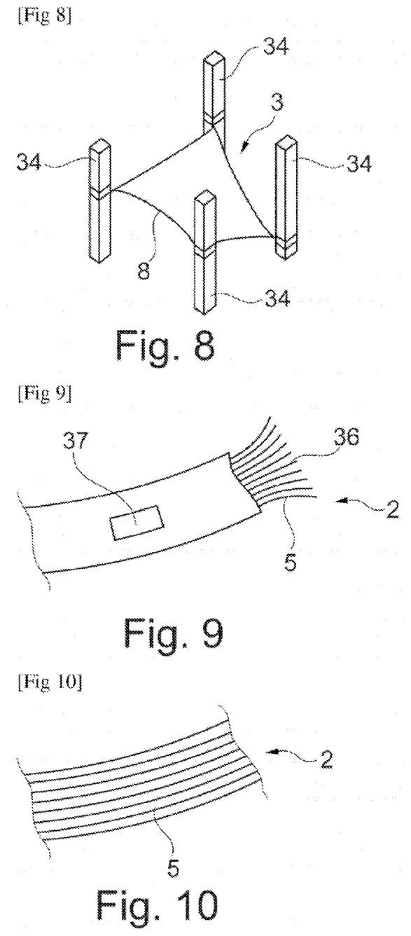

The substrate 3 can also have a flexible shape as in FIG. 8. In this example, such a substrate 3 is stretched by a rigid tool 34 with an opening which enables a mold to be formed.

In this case, the stitching head 25 can be configured to be able to stretch the substrate 3 locally in the stitching area, at an instant t, i.e. substantially perpendicular to the bobbin 27 and the needle 26 gradually as the stitching is produced, for example to improve the quality of the stitching of the strip 2 of fibers 5.

In this case, the method for manufacturing the preform 1 can comprise the step consisting of removing the surface of the substrate 3 delimited between the contour 8 and the contour 35.

The substrate 3 can comprise a thermoplastic polymer material, a thermosetting polymer material, and/or a woven fabric. It can also comprise other materials without departing from the scope of the invention.

The strips 2 of fibers 5 can be in the form of dry fibers, co-mixed fibers or pre-impregnated fibers.

The strips 2 of fibers 5 can also comprise, as in the embodiment illustrated in FIG. 9, one or more optical fibers 36 and/or an additional element 37, for example a sensor, an electronic circuit and/or a metal element.

The fibers 5 in the strip 2 can be parallel with one another and preferably oriented in the laying direction of the strip 2, as in the embodiment illustrated in FIG. 10. Such an arrangement can correspond to a strip 2 of fiber rovings.

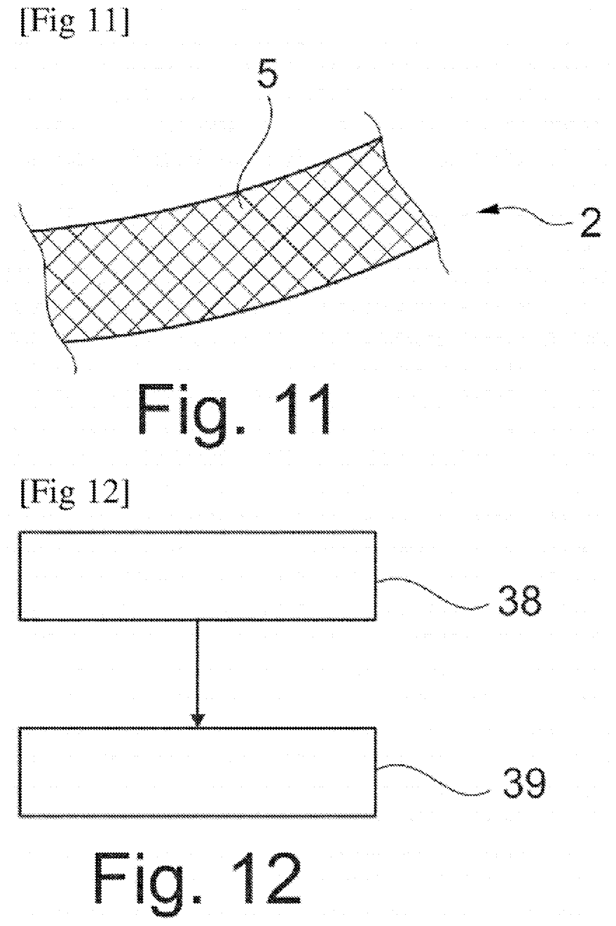

The fibers 5 in the strip 2 can also be interlaced with one another in different directions, as in the embodiment illustrated in FIG. 11. Such an arrangement can correspond to fibers 5 which are woven, knitted and/or in the form of rovings.

The invention also relates to a method for manufacturing a part made of composite material, comprising two steps.

The first step 38 of this method consists of producing a three-dimensional preform 1 according to the method described above, and then to shape the preform 1 in a second step 39.

In this step 39, the three-dimensional preform 1 is arranged in a tool, for example a mold, an oven, an autoclave or a press in order to shape it. It is possible to heat and/or compress the three-dimensional preform 1, in particular if it comprises strips of pre-impregnated fibers or strips of co-mixed fibers. As a variant, with the addition of a polymer material it is possible to infuse, impregnate, inject this in order to shape the part made of composite material, in particular when the three-dimensional preform comprises dry strips of fibers. It is also possible to add a ceramic matrix by gas cracking or pyrolysis of an organic material (polymer, coal tar pitch).

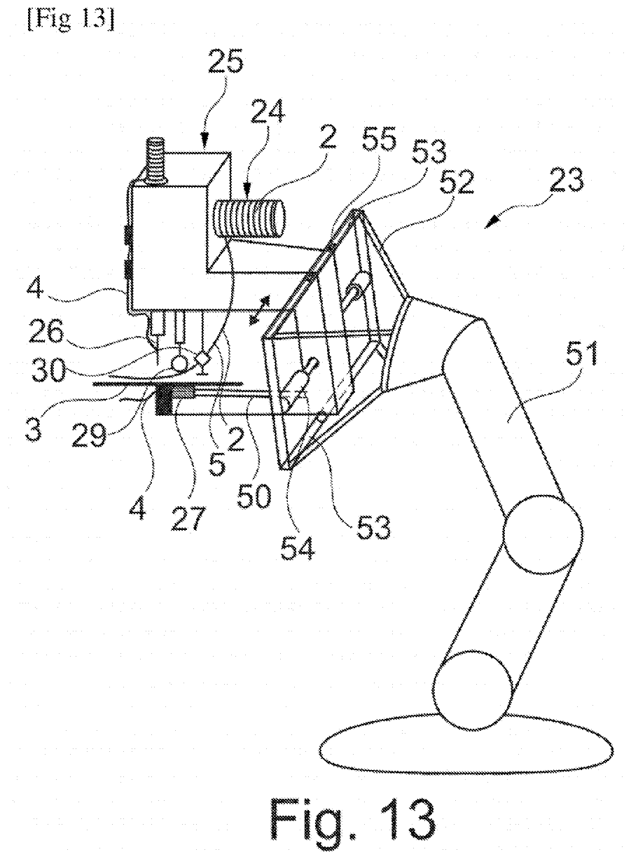

A further example of the installation 23 according to the invention is shown in FIG. 13.

The installation 23 comprises a robot 51 in the form of an arm articulated according to six axes, carrying a frame 52 which supports the arm 50 in the form of a gooseneck. The frame 52 comprises, at the top and bottom, rails 53 provided with bearings 55 and hydraulic cylinders 54. As can be seen, the arm 50 is supported by the frame 52 by an axle parallel to the rails 53, provided with hydraulic cylinders 54, and is mounted on the rails 53 so as to be able to be displaced along the double arrow.

The arm 50 supports the stitching head 25 and the laying head 24. The mounting on the rails 53 of the arm 50 in the form of a gooseneck permits the displacement of the stitching head 25 jointly with the laying head 24 and relative to the substrate 3. In this example the laying head 24 consists of a motorized unwinder which is fixed to the stitching head 25 and which enables the strip of fibers to be unwound whilst the robot advances.

The invention is not limited to the examples described above.

In particular, the number of plies can be different without departing from the scope of the invention.

Two adjacent plies can have an orientation of fibers differing by 45°, 90° or another angle, or not differing.

The strips of fibers 2 can be also produced in different materials and/or assembled in a different manner. For example, it is possible to have a mixture of carbon and glass fibers, both being dry or pre-impregnated.

1. A method for manufacturing a three-dimensional preform (1), comprising the following steps:
a) laying at least one strip (2) of fibers (5) on a three-dimensionally shaped substrate (3),
b) fixing by stitching said at least one strip (2) of fibers (5) on the substrate (3) with at least one stitching (6) thread (4).

2. The method as claimed in the preceding claim, wherein said at least one strip (2) of fibers (5) is laid on the substrate (3) so as to form a ply (9) of said three-dimensional preform (1), in particular with a predetermined orientation of the fibers (5).

3. The method as claimed in the preceding claim, comprising the repetition of steps a) and b) at least once, so as to form at least one additional ply (13) on the previously formed ply (9).

4. The method as claimed in any one of the preceding claims, wherein at least one strip (2) of fibers (5) is pressed against the substrate (3), in particular using a roller (29), before the fixing by stitching in step b).

5. The method as claimed in any one of the preceding claims, comprising the step consisting of cutting the strip (2) of fibers (5), or each strip of fibers, in particular after fixing by stitching, in at least one predefined location.

6. The method as claimed in any one of the preceding claims, wherein the fixing by stitching in step b) is carried out by displacing a stitching head (25), in particular using a robot or robot arm, relative to said at least one strip (2) of fibers (5).

7. The method as claimed in the preceding claim, wherein the stitching head (25) is displaced, preferably by means of a robot or robot arm, relative to said at least one strip (2) of fibers (5), both in the laying direction of the strip (2) and also transversely thereto on one side and then on the other side of said strip (2), forming stitches (7), in particular zig-zag stitches, on either side thereof.

8. The method as claimed in any one of the preceding claims, wherein said at least one strip (2) of fibers is unwound from at least one spool (28) before being laid in step a).

9. The method as claimed in any one of claims 1 to 8, wherein the substrate (3) is flexible, the method comprising the step consisting of stretching the substrate (3), locally or in its entirety, and carrying out step b) on the substrate thus stretched.

10. The method as claimed in any one of the preceding claims, wherein said at least one strip (2) of fibers (5) comprises at least one additional element (37), in particular at least one sensor and/or at least one electronic circuit and/or at least one metal element and/or any type of long body and/or any element which is continuous and of small width.

11. The method as claimed in any one of the preceding claims, wherein the strip (2) of fibers (5) comprises fibers selected from the group consisting of carbon fibers, glass fibers, ceramic fibers, fibers of polymer material, for example thermoplastic, in particular aramid fibers or polyester fibers, fibers of plant origin, in particular linen fibers, optical fibers, metal fibers, preferably carbon fibers and glass fibers, long bodies and a mixture thereof, the strip (2) of fibers (5) preferably having a shape selected from the group consisting of rovings, woven fabrics, knitted fabrics, braided fabrics and a mixture thereof.

12. The method as claimed in any one of the preceding claims, wherein the fibers (5) of said at least one strip (2) of fibers (5) are dry.

13. The method as claimed in any one of claims 1 to 11, wherein the fibers (5) of said at least one strip (2) of fibers (5) are pre-impregnated.

14. A method for manufacturing a three-dimensional part made of composite material, comprising the following steps:
producing a three-dimensional preform (1) using the method as claimed in any one of the preceding claims,
shaping the three-dimensional preform (1) by consolidation or adding a matrix.

15. An installation for implementing the method as claimed in any one of claims 1 to 13, comprising:
a three-dimensional substrate (3),
at least one laying head (24) comprising at least one spool (28) carrying said at least one wound-up strip (2) of fibers (5),
at least one stitching head (25) which is configured to stitch with at least one thread (4) said at least one strip (2) of fibers (5) on the substrate (3).

16. The installation as claimed in the preceding claim, wherein the laying head (24) comprises at least one blade (30) for cutting the strip (2) of fibers (5) and/or at least one pressing member (29), in particular a roller, for pressing said at least one strip (2) of fibers (5) against the substrate (3).

17. The installation as claimed in claim 15 or 16, comprising a fiber placement machine (TFP) and an arm (50), preferably robotized, in particular in the form of a gooseneck, carrying at least one stitching head (25) holding the bobbin (27) fixedly relative to the needle (26) whilst surrounding the substrate (3).

18. The installation as claimed in claim 17, wherein the stitching head (25) is configured to be displaced, in particular by the arm (50), relative to said at least one strip (2) of fibers (5) so as to produce stitches (7), in particular zig-zag stitches, on either side thereof whilst at the same time advancing.

19. The installation as claimed in any one of claims 15 to 18, comprising a plurality of spools (28), each carrying at least one wound-up strip (2) of fibers (5) and a plurality of stitching heads (25) which are coupled to the spools (28).
